(19) United States
(12) Patent Application Publication
(10) Pub. No.: US 2017/0220957 A1
(43) Pub. Date: Aug. 3, 2017

(54) RESTAURANT RESERVATION AND TABLE MANAGEMENT SYSTEM AND METHOD

(71) Applicant: Flo, LLC., New York, NY (US)

(72) Inventors: Albert C. Lee, New York, NY (US); Eric J. Blatstein, New York, NY (US)

(21) Appl. No.: 15/012,031

(22) Filed: Feb. 1, 2016

(51) Int. Cl. G06Q 10/02

(52) U.S. Cl. CPC G06Q 10/02

(57) ABSTRACT

A method for optimizing seating capacity at a business establishment using a data processing system. Patrons of the establishment can request reservations using a computing device. Once the request has been made, the system determines whether one or more floor plan configurations have an available table capable of satisfying the request and reservation requirements. If the request can be satisfied, the reservation is confirmed and the table is assigned within the selected floor plan configuration and recorded within the reservation requirements. Walk-in patrons may also request a table. The system will produce floor plan configurations having an available table to accommodate the request in accordance with reservation requirements and business information. Business information includes data received from table activity, kitchen activity, and server activity, as well as patron requirements. The system can also predict a patron's wait time based on floor plan configuration and business information.

### FIELD OF THE INVENTION

The present invention relates generally to restaurant management systems, and more particularly to a restaurant reservation and table management system for optimizing seating capacity.

### BACKGROUND OF THE INVENTION

Restaurant seating is complicated and with the addition of walk-in patrons can be highly unpredictable. While reservations provide some level of predictability, walk-ins who are seated can limit the ability to seat reserved parties later in the evening. As a restaurant fills up, the highly dynamic nature of the dining and the combination of reserved and unreserved patrons will create unpredictable vacancies that make it almost impossible to anticipate where a reserved party will sit in the restaurant.

Restaurant managers, host station staff, or a maitre d traditionally traffic how patrons are seated based off of table availability and a “best guess” of how they think seating will affect upcoming reservations. While this is potentially easy at the beginning of service when the restaurant is predominantly vacant and the service staff and kitchen slow, once the dining space begins to fill-up and the service staff and kitchen become busy, the ability to achieve maximum occupancy becomes impossible to predict.

Therefore, there exists a need to provide a restaurant reservation and table management system that can accurately suggest where to seat patrons, predict seat availability and forecast wait times.

### SUMMARY OF THE INVENTION

The present invention relates to a restaurant reservation and table management system and method that optimizes a restaurant's seating capacity by eliminating the guesswork associated with restaurant seating.

In accordance with an illustrative embodiment of the present invention, a method for managing reservations and seating capacity at a business establishment is provided. The method includes receiving, at a data processing system, a request from a patron to reserve a table, wherein the request includes a party size on a requested date at a requested time. Next, the method includes retrieving, at a data processing system, business information and reservation requirements for the requested date and requested time, wherein the business information includes a plurality of floor plan configuration records from a database associated with the business establishment, the floor plan configuration records having a plurality of tables, each table being listed as available or unavailable. The method then identifies, at the data processing system, at least one of the plurality of floor plan configuration records having at least one table being listed as available and capable of accommodating the request and satisfying the reservation requirements. The request is then approved or declined at the data processing system. If the request is approved, the business establishment has at least one available table within at least one floor plan configuration record to satisfy the request and the reservation requirements. If the request is declined, the business establishment has insufficient available tables within at least one floor plan configuration record to satisfy the request and the reservation requirements.

The method can further include approving the request and selecting, at the data processing system, an available table within the associated floor plan configuration record, and assigning, at the data processing system, the selected table to the approved request within the associated floor plan configuration record.

The method can further include updating, at the data processing system, the floor plan configuration record by listing the selected table as unavailable, and updating, at the data processing system, the reservation requirements to include a reservation record for the approved request.

The method can further include receiving, at the data processing system, reservation information from a patron via a tablet, the reservation information includes a request to check-in for an existing reservation and a tablet physical location. The method then determines, at the data processing system, the estimated arrival time of the patron based on the proximity of the tablet location to the business establishment, and updates, at the data processing system, the reservation record in accordance with the estimated arrival time.

The method can further include retrieving, at a data processing system, the reservation record of a patron associated with the reservation requirements. Then the method calculates, at the data processing system, an expected wait time in accordance with the floor plan configuration record and reservation requirements, and notifies the patron of the expected wait time.

The step of identifying at least one of the plurality of floor plan configuration records can further include defining, at the data processing system, a set of requirements for a floor plan configuration record. Then producing, at the data processing system, all possible floor plan configuration records which satisfy the set of requirements, wherein each possible floor plan configuration record having at least one available table. Finally identifying, at the data processing system, a floor plan configuration record which optimizes seating capacity in accordance with the request and the reservation records. The method can include a set of requirements including a blocked table list. This may occur when tables are blocked for VIPs, or are unable of being combines, or must be blocked for specific walk-in patrons (e.g. the business establishment owner, or frequent celebrity patron, etc.).

The step of identifying at least one of the plurality of floor plan configuration records can further include retrieving, at the data processing system, a patron record from a database associated with the business establishment, the patron record having a plurality of patron preferences. Then identifying, at the data processing system, at least one of the plurality of tables being listed as available and satisfying the reservation requirements and at least one of the plurality of patron preferences. The plurality of patron requirements can include at least one of preferred table location, preferred table type, or preferred server.

The business information can further include a plurality of databases associated with the business establishment, each database having a plurality of records, each of the plurality of records including a list of data fields for storing real-time business information. The plurality of databases can include at least one of table activity, kitchen activity, and server activity.

The method can further include monitoring, at the data processing system, a plurality of data fields associated with records from the table activity database, kitchen activity database, and server activity database. Then receiving, at the data processing system, a request from a walk-in patron for a table, wherein the request includes a party size. Then the method optimizes, at the data processing system, seating capacity by reconfiguring the plurality of tables within the floor plan configuration record to accommodate the walk-in request and satisfy the reservation requirements in accordance with real-time business information being monitored within the table activity database, kitchen activity database, and server activity database. Finally identifying, at the data processing system, at least one available table within the reconfigured floor plan configuration record which satisfies the request and reservation requirements.

The method can further include having a table that is available, unavailable, or not yet available table for accommodating the walk-in request, at the data processing system. If the table is available, then the patron is seated. If the table is not available, then patron is turned away. If the table is not yet available, then the patron is provided with an expected wait time.

The method can further include calculating, at the data processing system, the expected wait time in accordance with the floor plan configuration record, reservation requirements, and data fields monitored within the table activity database, kitchen activity database, and server activity database. Then, notifying the patron of the expected wait time. During the expected wait time, the method can include recalculating, at least once, at the data processing system, the remaining expected wait time.

The patron can submit a reservation request via a digital computing device. The data processing system can be a server.

In accordance with another illustrative embodiment of the present invention, an article of manufacture including non-transitory, tangible computer readable storage medium having instructions stored thereon that, in response to execution by a processor of a data processing system, cause the data processing system to perform operations is provided. The article includes receiving, at a data processing system, a request from a patron to reserve a table, wherein the request includes a party size on a requested date at a requested time. Then retrieving, at a data processing system, business information and reservation requirements for the requested date and requested time, wherein the business information includes a plurality of floor plan configuration records from a database associated with the business establishment, the floor plan configuration records having a plurality of tables, each table being listed as available or unavailable. Next identifying, at the data processing system, at least one of the plurality of floor plan configuration records having at least one table being listed as available and capable of accommodating the request and satisfying the reservation requirements. The request is then approved or declined at the data processing system. If the request is approved, then the business establishment has at least one available table within at least one floor plan configuration record to satisfy the request and the reservation requirements. If the request is declined, then the business establishment has insufficient available tables within at least one floor plan configuration record to satisfy the request and the reservation requirements.

These advantages of the present invention will be apparent from the following disclosure and appended claims.

### BRIEF DESCRIPTION OF THE DRAWINGS

FIG. 1 depicts a block diagram of an exemplary business environment within which embodiments of a restaurant reservation and table management system may be practiced.

FIG. 2 depicts a block diagram of an embodiment of a server of the restaurant reservation and table management system.

FIG. 3 depicts a block diagram of additional components of the restaurant reservation and table management system.

FIG. 4A depicts an example record of a floor plan database of FIG. 3.

FIG. 4B depicts an example record of a reservation database of FIG. 3.

FIG. 4C depicts an example record of available reservation database of FIG. 3.

FIG. 4D depicts an example record of a patron information database of FIG. 3.

FIG. 4E depicts a flow chart of an exemplary method of dynamically determining reservation availability in accordance with the present invention.

FIG. 4F depicts a flow chart of an exemplary method of forecasting wait times for tables in accordance with the present invention.

FIG. 5 depicts a flow chart of steps performed by the reservation and table management system implementing an example method for making restaurant reservations and managing table inventory in accordance with the present invention.

FIG. 6 depicts a flow chart of steps performed by the reservation and table management system implementing an example method for identifying available tables in a restaurant and forecasting wait times for walk-in patrons in accordance with the present invention.

FIG. 7 depicts a flow chart of steps performed by the reservation and table management system implementing an example method for forecasting wait times for existing reservations prior to and/or upon arrival at the restaurant in accordance with the present invention.

### DETAILED DESCRIPTION

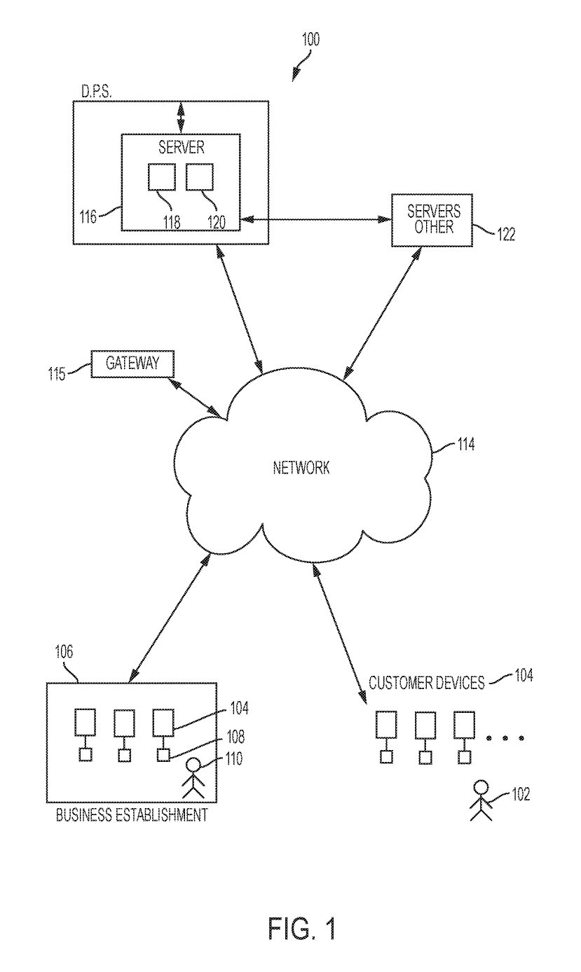

FIG. 1 is a block diagram illustrating an exemplary embodiment of a system and method for managing restaurant reservations and table inventory in an environment in which it can be used. More particularly, FIG. 1 depicts one or more patrons 102 using digital computing devices 104 to reserve tables in a business establishment 106 through reservation data processing system (DPS) 100. Business establishment 106, preferably a restaurant, includes one or more digital computing devices 104 and customer service staff 110. Reservation data processing system 100 and digital computing devices 104, communicate with one another via wide area network 114, such as the Internet, and gateway 115 among any other modes of communication.

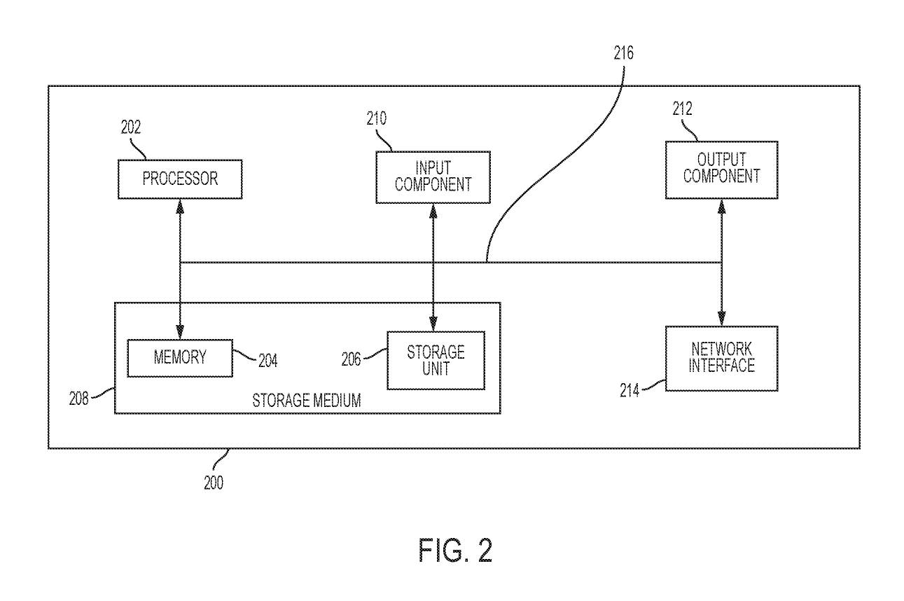

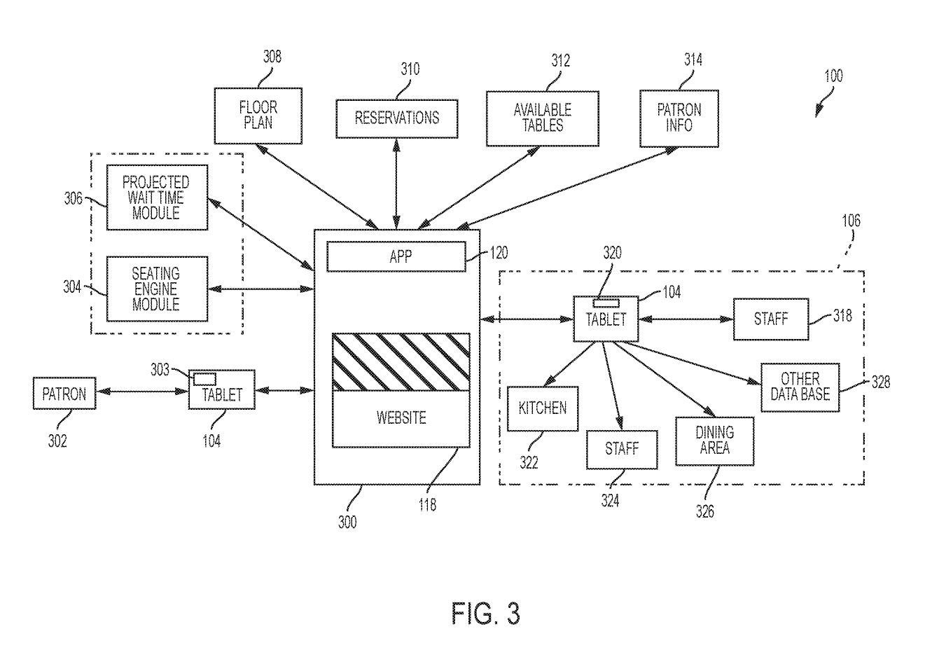

In accordance with the preferred embodiment of the present invention, reservation data processing system is realized as a server 116 accessible by the plurality of digital computing devices 104. Server 116 may be a web server on the World Wide Web for providing a web-based interface, website 118, for accessing reservation data processing system 100. Server 116 may include one or more software applications (“app”) 120 stored in processor-accessible memory and suitably configured to interface with wide area network 114, such that patrons can search for available reservations at restaurants and book available reservations. Server 116 is described in further detail in conjunction with FIGS. 2 and 3.

Patrons, restaurant managers, and service staff may use digital computing devices 104 to access reservation data processing system 100 over network 114. In accordance with the illustrative embodiment, digital computing device 104 is a “tablet” computer, such as, for example, an Apple iPad®, Android tablet, Samsung Galaxy Tab models, or the like. However, in some other embodiments, digital computing device 104 can take other forms, such as smart phone, lap-top computer, etc. The terms “digital computing device” and “tablet” are used interchangeably herein to refer to the patron-side and restaurant-side devices for use in conjunction with embodiments of the invention. In some embodiments, digital computing device 104 used by patrons includes a software application that provides interfaces for searching available times and tables and for making reservations. In some embodiments, digital computing device 104 used by restaurants includes a software application that provides interfaces for retrieving and entering management and reservation information for the restaurant. The patron-side and restaurant-side applications may be made available for downloading from an App Store. In other embodiments, a browser-based network interface may also be provided.

Digital computing device 104 may include a database 108 or other files that store local copies of information from server 116. In other embodiments, the digital computing device 104 may include one or more of network device 200 as depicted in FIG. 2 and discussed in detail below.

Although restaurants are preferred business environments for using embodiments of the invention, it is to be understood that embodiments of the invention can be used in other business environments. For example, the data processing system can be used and the method performed in the context of any retail establishment or services provider environment that provides reservations for goods or services and/or waiting queues. In the case of a nail salon, for example, tablets can be situated at the front entrance of the salon to allow walk-in customers to see expected wait times for getting a manicure and make a reservation.

FIG. 2 is a block diagram of an exemplary embodiment of reservation data processing system 100, embodied as server 116, in accordance with an illustrative embodiment of the present invention. Server 116 may include one or more network devices 200. As depicted, network device 200 may include processor 202, computer-readable storage medium 208, input component 210, output component 212, network interface 214, and communication path 216. In some embodiments, network device 200 may include additional, fewer, different, or various arrangements of components than the ones illustrated in FIG. 2. For example, network device 200 may include line cards for connecting to external buses.

Processor 202 is a general-purpose processor that is capable of, among other tasks, controlling network device 200, executing an operating system, executing specialized application software used in conjunction with the embodiments of the invention, and populating, updating, using, and managing data stored in memory 204 and/or storage unit 206. In some embodiments, the processor 202 is a special purpose processor. It will be clear to those skilled in the art how to make and use processor 202.

As used herein, the term “computer-readable storage medium” 208 may include memory 204, storage unit 206, or a combination of the two. Computer-readable storage medium is a non-volatile, non-transitory memory technology that stores, among other software and data, specialized application software, such as discussed in FIG. 3, which, when executed, enable processor 202 to perform features and tasks of various embodiments of the present invention. In the illustrated embodiment, computer-readable storage medium 208 of digital computing devices 104 may store local copies of information from database of server 116. Memory 204 may include static memory, such as read only memory (ROM), and/or dynamic memory, such as random access memory (RAM), or onboard cache, for storing data and machine-readable instructions. Data regarding patrons, restaurants, floor plans, table availability, wait times, and reservations may be stored in memory 224 associated with server 116. Storage unit 206 may include a floppy disk, CD ROM, DVD, CD read/write (R/W) disc, and/or flash memory, or other solid-state storage devices for storing data and/or machine-readable instructions. It will be clear to those skilled in the art how to make and use processor-accessible memory 204 and storage 206.

The term “non-transitory” is to be understood to remove only propagating transitory signals per se from claim scope and does not relinquish rights to all standard computer-readable media that are not only propagating transitory signals per se.

Input component 210 and output component 212 may provide input and output from/to patron and to/from network device 200. Input and output components 210 and 212 may include a display screen, a touch screen, a monitor, a keyboard, a mouse, a speaker, a serial link, a microphone, a camera, a DVD reader, a Universal Serial Bus (USB) port, and/or other types of components for converting physical events to or from signals pertaining to network device 200.

Network interface 214 may include a transceiver for network device 200 to communicate with other devices and systems, via one or more communication protocols (e.g. Bluetooth, WiFi, cellular, etc.). Digital computing device 104 is suitably configured to communicate with servers (e.g. server 116, remote servers 122 (e.g. Opentable), etc.) accessible via a WAN such as the Internet, so as to transmit inquiries for table seating and to transmit its location so that suitable reservations can be made for the patron. It will be clear to those skilled in the art how to make and use network interface 214. Communication path 216 may provide an interface through which components of network device 200 communicate with one another.

FIG. 3 depicts a block diagram illustrating components of reservation data processing system 100 in accordance with the present invention. Server 116, embodied as web server 300, is accessible by patrons 302 over the Internet, using digital computing device 104. Web server 300 may be a client-server system that runs all of the programs and accesses all of the databases that are made available for managing restaurant 106.

In particular, web server 300 runs software 120 that provides table seating logic and determines wait times, in response to a patron request for a table, submitted using digital computing device 104. In particular, storage medium 208 of server includes the following specialized application software: seating engine module 304 and wait time module 306. It is to be understood that software module is a “logical” entity in the sense that some or all of the functionality provided by the module can be performed by any other module or all the functionality can be combined into a single module or any number of modules as appropriate. The same is true of the databases.

Seating engine module 304 is software which functions to filter the list of floor plan configurations, seating parameters, and rules for determining seat availability. This software provides the logic that enables the server 300 to reconfigure a restaurant's floor plan, taking into consideration existing reservations and seated tables, in order to predict seat availability and optimize restaurant capacity. With respect to table availability, seating engine module 304 enables processor 202 of server to check status of seated tables and upcoming reservations and reconfigure floor plans and table assignments to optimize seating arrangements.

The wait time module 306 is also software that enables processor 202 of server to provide a walk-in patron or patron with an existing reservation an accurate expected wait time. As to obtain wait time, the wait time module 306 can cause the processor 202, for example, to check on actual seating times of previous reservations to determine on average how long the wait may be.

Software 120, including seating engine module 304 and wait time module 306 applications, on web server 300, cause processor 202 to accesses databases, which store information required by server 300 for operating the reservation data processing system 100. Server 300 updates information stored in databases on on-going bases. Databases include a floor plan database 308 for storing information regarding floor plan, tables configurations and seating assignments for restaurant 106, a reservation database 310 for storing information regarding reservations that have been made, an available reservations database 312 for storing information about available reservations, and a patron database 314 for storing information about patrons making reservations. In other embodiments, web server 300 can cause processor to access additional databases, including those stored locally on tablets 104.

As depicted in FIG. 1, restaurant staff 318 may also access system 100 through tablet 104. In particular, as illustrated in FIG. 3, tablet may have software application 320 that can be downloaded from an App store. System 100 may include one or more staff accounts for the restaurant 106 with password protection to allow service staff to access application 320 and system 100. In accordance with the preferred embodiment, application 320 accesses local databases or files, including a kitchen database 322 for storing information about the efficiency and workflow of the kitchen, a staff database 324 for storing information about service staff, a dining area 326 database for storing information about table inventory and progress throughout meal service. When service staff 318 requests a table through the system 100 for a walk-in or future reservation using application 320, reservation database 310, available reservation database 312, and guest database 314 are all updated on web server with walk-in or future reservation information.

In some embodiments, application 320 may access a variety of other databases 328 or files stored locally, including a floor plan database, seating engine database, reservation database, available table database, patron information database etc. In this embodiment, when service staff 318 makes a walk-in or future reservation through application 320 locally, reservations database 310, available reservations database 312 and patron information database 314 may be updated on web server 300 in addition to storing the information in the corresponding local databases.

In other embodiments, application 320 may provide a module for integration with a point-of-sale (POS) system used by the restaurant to management payment transactions for the establishment. This information may be accessed by seating engine module 304 to reconfigure seating assignments and more efficiently manage reservations.

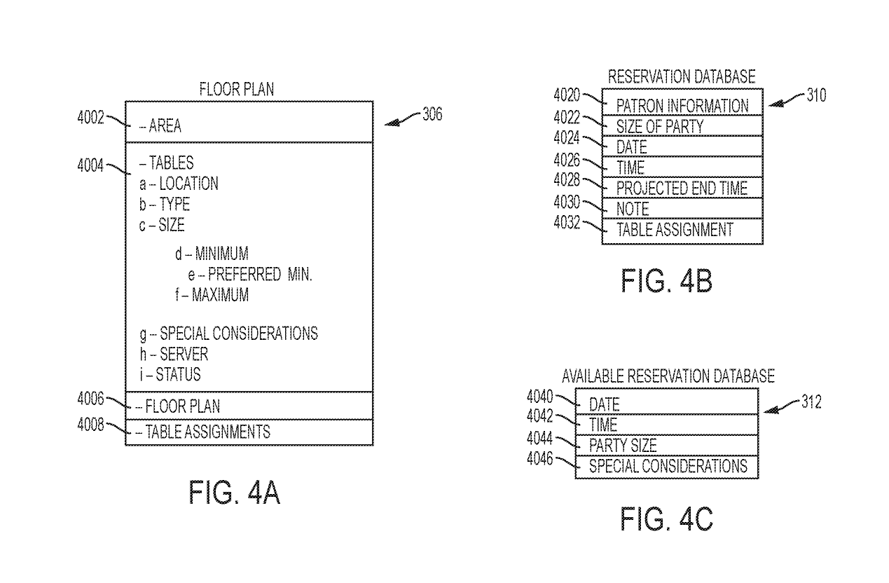

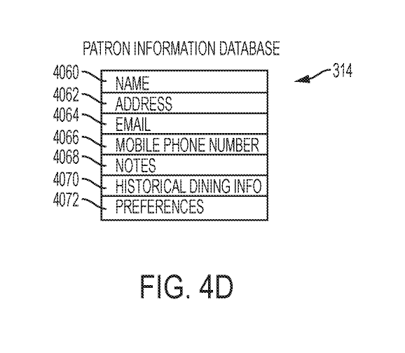

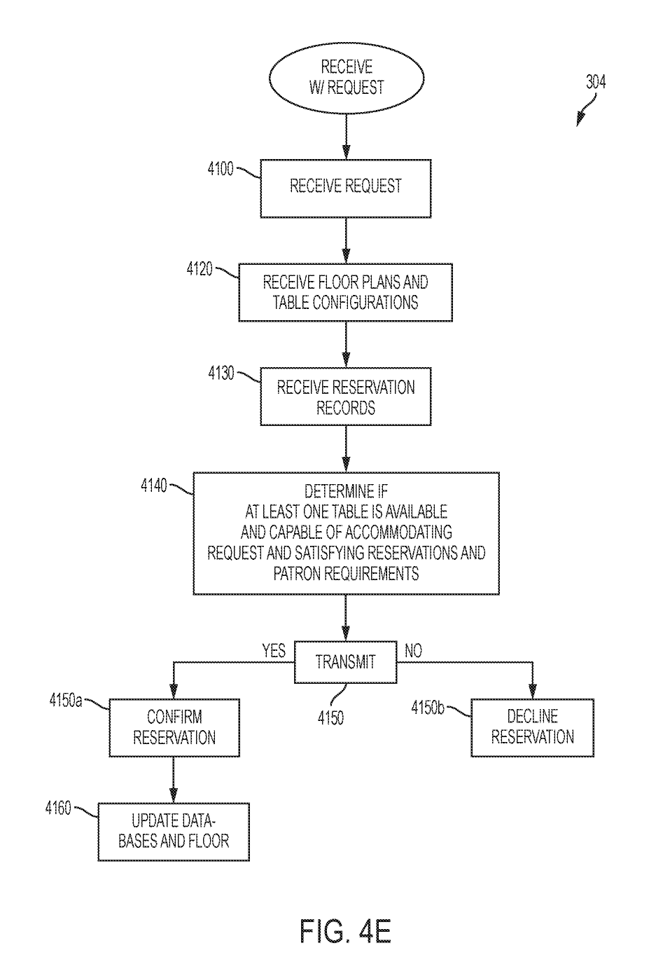

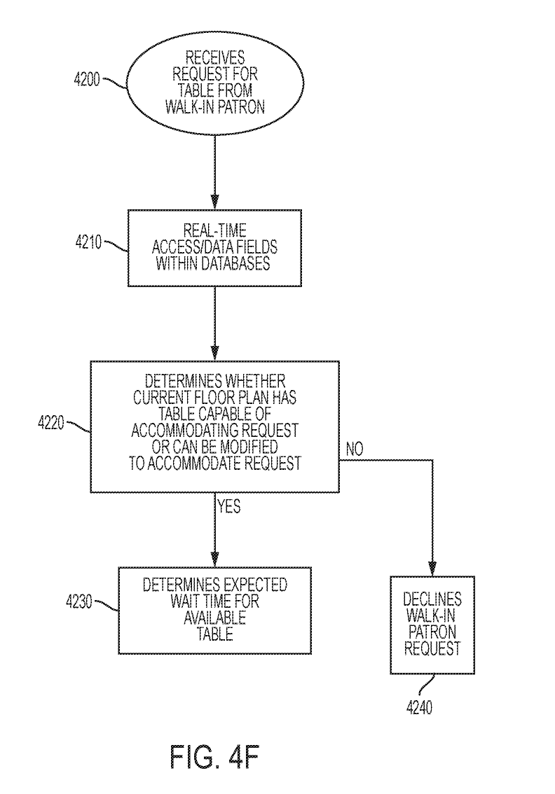

FIGS. 4A-4D illustrates some of the contents of processor-accessible storage medium 228 on web server 116. In the preferred embodiment of the present invention, computer-readable storage medium 228 contains seating engine module 304, wait time module 306, floor plan database 308, reservation database 310, available reservation database 312, and patron database 314. In other embodiments, one or more modules and/or databases may be stored on one or more web servers, and/or on one or more local servers, accessible by web server 300 over network 114.

FIG. 4A illustrates an exemplary record in floor plan database 308. The records represent floor plan and table configuration for a restaurant. It is to be understood that this is only one example, and that in other embodiments, database 308 may include additional tables, records, or data fields for floor plans and tables for restaurants. As depicted, the record for floor plan database 308 for restaurant 106 may include a data field identifying areas 4002 of restaurant 106. Each area 4002 may have a group of tables 4004 assembled in a variety of different configurations to define a floor plan 4006 of restaurant 106. Each table record 4004 may include a data field identifying one or more possible locations 4004a of tables, which may include both the area and location in the area where the table is located. Each table record 4004 may also include a data field specifying the type of table 4004b. Each table record 4004 may also include a data field indicating a minimum 4004c size of the party for which the table may be reserved, and may further include a preferred minimum 4004d with the preferred minimum size of the party. Each table record 4004 may also include a data field indicating a maximum 4004e size of the party for which the table may be reserved. This information is used to determine whether a reservation can be assigned to a particular table. Each table record 4004 may also include a data field indicating reservations 4004f that have been assigned to the table. The reservations data field 4004f may include links into records of the reservations database 310 for reservations that have been assigned to the tables. Those table records 4004 that do not have a reservation assigned may be included in records of available reservations database 312. A data field may be included to specify additional or special considerations 4004g (e.g. handicap accessible, smoking/non-smoking, view, indoor/outdoor, bar area, booth, etc.). A data field may also be included to indicate server assigned 4004h to the table. A data field may also be included to identify status 4004i of the table at a given time, which may include whether the table is available for seating and/or if a party has been seated where they are in the course of their meal and when they may be expected to finish. Table records may be used to generate floor plan views of the restaurant including seat assignments 4008.

FIG. 4B illustrates an exemplary record in reservation database 310. These records indicate reservations that have been booked by patrons 102 or service staff, including those wait-listed for a table. It is to be understood that this is only one example, and that in other embodiments, database may include additional tables, records, or data fields for reservations. As depicted, the record for each reservation may include a data field for patron information 4020. Patron information data field 4020 may include a link to patron information database 314 for specified patron. The record for reservations may include a data field for entering the party size 4022, which be broken down to include number of children and adults. The record for reservations may include a data field for indicating a date 4024 of reservation, and a data field for indicating a time of reservation 4026, which will be updated real-time to reflect the actual date and time the party is seated. The record for reservations may also include a data field for indicating the projected end time 4028, which will be calculated according to an algorithm described below. The projected end time data field 4028 may include a link to remote databases of the restaurant 106, including data from kitchen database 322, staff database 324, dining area database 326 and various other databases 328 storing real-time information specific to each patron and table considered for calculating estimated end time. The record for reservations may also include a data field for indicating notes 4030, which may include additional considerations for seating the party. The notes data field 4030 may include, for example, a link to patron information database 314 in order to populate information about the specified patron, including a preferred table or server. The record for reservations may also include a data field for indicating projected table assignment 4032, which will be updated real-time to reflect actual table assignment to which the party has been seated.

It should be understood that the present invention can also integrate with existing reservations systems and databases (e.g. opentable, etc.), which are capable of receiving reservation requests from patrons, as well as, compiling a wait-list for reservations.

FIG. 4C illustrates an exemplary record in available reservation database 312. It is to be understood that this is only one example, and that in other embodiments, database may include additional tables, records, or data fields for available reservations. As depicted, the record available reservations may include a data field for date of reservation 4040. The record for available reservations may include a data field for time of reservation 4042. The record for available reservations may include a data field for party size for reservation 4044, which may include number of children and adults. The record for available reservations may also include a data field for special considerations 4046 for reservations (e.g. if only a booth or bar seating is available on a specific date and time etc.).

FIG. 4D illustrates an exemplary record in patron database 314. It is to be understood that this is only one example, and that in other embodiments, database may include additional tables, records, or data fields for patron information. As depicted, the record for patron information may include a data field for patron name 4060, a data field for patron address 4062, a data field for patron email 4064, and a data field for patron mobile phone number 4066. The record for patron information may include a data field for notes 4068 including allergies the patron may have or specific bottles of wine the patron may like to order. The record for patron information may include a data field for historical dining information 4070, which may include previous reservations, whether the patron is punctual for reservations or late, and if late, on average how late. The record for patron information may include a data field for preferences 4072, which may include a preferred table location, preferred type of table, preferred server, or preferred seating time.

It should be understood that the various data fields illustrated within databases and modules of the system 100 are capable of including a pointer or index into any one or more records of another database and/or module through network 114. It should also be understood that processor 202 is capable of accessing all data fields to provide modules with information necessary to process and filter logic rules and parameters.

In the illustrative embodiment, shown in FIG. 4E, seating engine module 304 represents rules and/or parameters used by the system 100 to dynamically determine reservation availability. In exemplary embodiments, module 304 provides the following functionality: receives a request for a reservation for a party size on a specific date and time 4100; accesses available reservation database 4110, floor plan and table configuration database 4120, and reservation database 4130; determines whether a floor plan configuration exists having an available table capable of accommodating the request and satisfying the existing reservation records and patron requirements 4140; and transmits 4150 to the tablet either the available table for confirmation of the reservation 4150a or declines the reservation when no table is available 4150b; if the reservation is confirmed, updates are made to reservation database, available reservation database, patron information database, and floor plan and seating assignments database 4160.

To determine availability of a request for a reservation, seating engine module 304 may compare confirmed reservations with various configurations of tables that define floor plan in restaurant 106 in an effort to reconfigure tables to accommodate the request. Seating engine module 304 may also consider a variety of data fields stored within various databases including real-time data received for each reservation (e.g. when reservation is seated, when reservation pays bill, when reservation leaves, etc.) real-time data stored locally within kitchen, staff and/or dining databases of restaurant 106 (e.g., kitchen orders are running 5 minutes behind, dining room is understaffed by 2 servers, specific table orders dinner or is paying their bill, etc.). Seating engine module 304 receives and considers data projected from wait time module 304 as well, in order to determine most efficient seating configuration.

The rules may also specify how to handle cancelled reservations and changes to existing reservations.

In the illustrative embodiment, shown in FIG. 4F wait time module 306 represents rules and/or parameters used by system 100 to dynamically forecast the amount of time patron must wait for a table. Module 306 includes forecasting wait times for patrons with reservations as well as walk-ins. In exemplary embodiments, module 306 provides the following functionality: receives an immediate request for a reservation via a walk-in patron, accesses real-time data within reservation database 4200 (e.g. when reservations arrive, are seated, and when reservations leave, etc.), accesses real-time data stored locally within kitchen, staff and/or dining databases of restaurant 4210, and determines whether the current floor plan configuration and seated tables has an available table capable of accommodating the request, or can be modified to accommodate the request, while still satisfying the existing reservation records and patron requirements 4220, and determines the expected wait time for the available table 4230 or declines request if no table is available 4240.

In the illustrative embodiment, wait time module 304 is also capable of forecasting expected wait times for existing reservations, particularly once patrons arrive at restaurant 106 and are waiting to be seated, which are similarly forecasted based on rules and parameters discussed above.

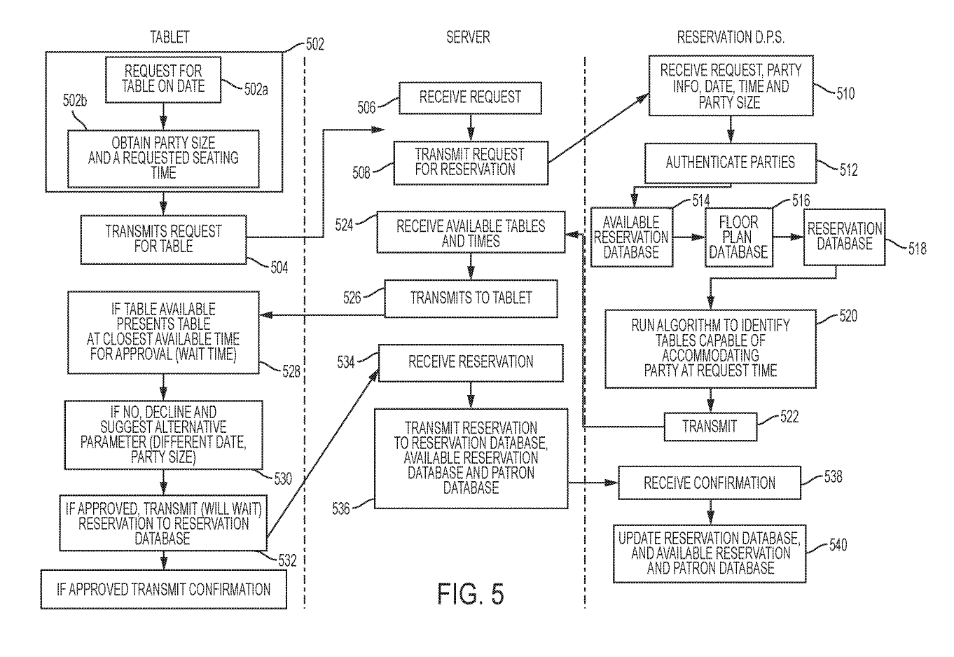

FIG. 5 is a flow chart illustrating an exemplary method 500 by the reservation data processing system 100 for making restaurant reservations and managing table inventory in accordance with embodiments of the present disclosure. It is to be understood that the order of the steps depicted in FIG. 5 are by way of illustration, not limitation. As appropriate, a number of the steps can be performed in a different order than presented. Method 500 may provide functionality that enables server 300 associated with reservation data processing system 100 to identify one or more tables within a restaurant 106 capable of accommodating a requested patron at a specified date and time. In certain embodiments, the server 300 may identify one or more tables based on at least one of a dynamic slotting mechanism implemented by the server, expected and actual table utilization by the restaurant, rate limits for the restaurant at the requested date and time, expected and actual kitchen production output at the restaurant, service staff efficiency information, dining area information including progress of patrons meal and point-of-sale (POS) information, preferences and historical data of patrons within the requested reservations, and location of patrons within the requested reservations at the requested date and time.

In step 502, tablet 104 receives a request for a table reservation on a specific date 502a, for a particular number of patrons 502b. In step 504, tablet 104 transmits, to server 300, a request for a reservation.

Server 300 receives the request and patron information in step 506. In step 508, server 116 transmits a request for a reservation, along with patron information, to reservation data processing system 100.

Reservation data processing system 100 receives the request and patron 102 information in step 510. In step 512, reservation data processing system 100 authenticates the patron by accessing the patron information database to check patron's record. In step 514, reservation data processing system 100 searches available reservation database for available table. In step 516, reservation data processing system accesses reservation database to determine existing reservations. In step 518, reservation data processing system accesses floor plan to determine plurality of seating configurations. In step 520, the reservation data processing system identifies tables capable of accommodating party at, or as close to, requested time, which may require reconfiguring restaurant floor plan and existing reservation table assignments in order to accommodate request. In step 522, the reservation data processing system transmits available table information and seating time to server.

Server 300 receives the available table information and seating time in step 524. In step 526, server 300 transmits available table information and seating time to tablet 104. In step 528, tablet 104 receives available table information and seating time and presents reservation to patron 102 for confirmation. If reservation not confirmed, in step 530, reservation is declined and patron may request another reservation by suggesting other parameters and beginning method at step 502. If confirmed, reservation and patron information is transmitted to server 300 in step 532. In step 534, server receives the reservation and patron information. In step 536, server 300 transmits them reservation and patron information to reservation data processing system 100. In step 538, reservation data processing system 100 receives confirmed reservation and, in accordance with step 540, server 300 updates reservation database, available reservation database, floor plan database, and patron information.

System 100, using software module 304, may identify available table and seating inventory in step 520 that optimizes restaurant capacity, while considering existing reservations, configurability of floor plan, and overall performance of the kitchen and serving staff. For example, system 100 may determine in step 520 that a six-person party requesting a reservation at 8 can be accommodated at 7:45 if floor plan is reconfigured for earlier reservations. In such instances, reconfiguring floor plan will increase seating capacity of restaurant 106.

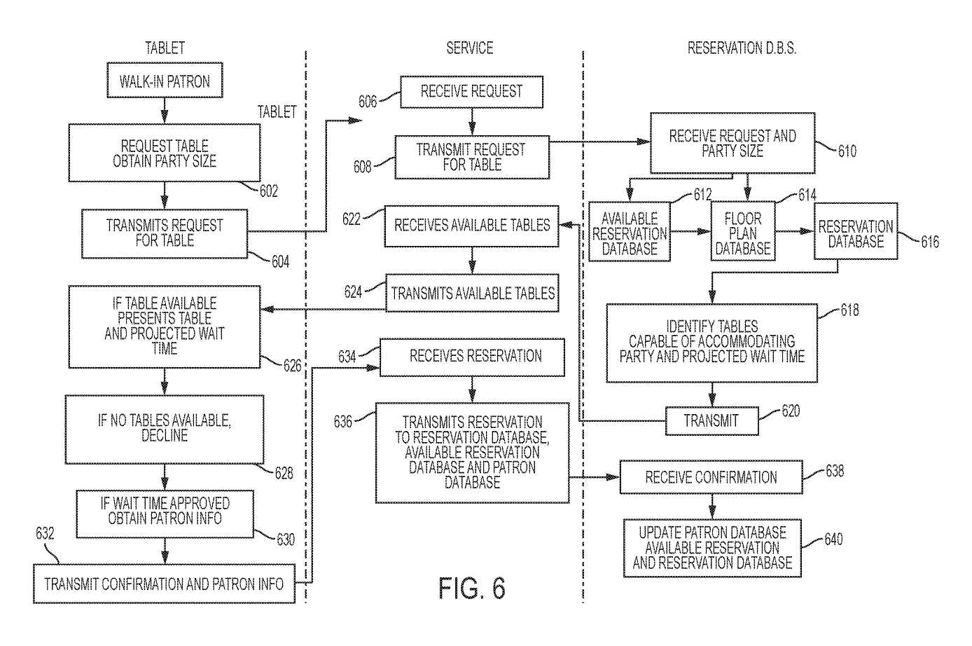

FIG. 6 is a flow chart illustrating an exemplary method 600 by reservation data processing system 100 for identifying available tables in a restaurant and forecasting wait times for walk-in patrons. As described above in reference to FIG. 5, server 116 may receive a request to identify tables available at restaurant 106 capable of accommodating a walk-in party immediately. It is to be understood that the order of the steps depicted in FIG. 6 are by way of illustration, not limitation. As appropriate, a number of the steps can be performed in a different order than presented.

In step 602, tablet 104 receives a request for a table reservation for a particular number of patrons. In step 604, tablet 104 transmits, to server 300, a request for a table.

Server 300 receives request in step 606. In step 608, server 300 transmits a request for a table to reservation data processing system 100.

Reservation data processing system 100 receives request in step 610. In step 612, reservation data processing system searches available reservation database for an available table. In step 614, reservation data processing system accesses reservation database to determine existing reservations. In step 616, reservation data processing system accesses floor plan to determine plurality of seating configurations. In step 618, the reservation data processing system, using software module 304, identifies tables capable of accommodating party at, or as close to, the present time, which may require reconfiguring restaurant floor plan and existing reservation table assignments in order to accommodate request. In step 620, reservation data processing system 100 transmits available table information and projected wait time to server.

Server 300 receives available table information and expected wait time in step 622. In step 624, server 300 transmits available table information and expected wait time to tablet 104. In step 626, tablet 104 receives available table information and expected wait time and presents information to patron for approval. If wait time not approved, or no tables are available, in step 628, request is declined. If wait time approved, in step 630, host obtains patron information and, in step 632, transmits information and reservation confirmation to server 300. In step 634, server 300 receives reservation and patron information. In step 636, server 300 transmits reservation and patron information to reservation data processing system 100. In step 638, reservation data processing system receives confirmed reservation and patron information, in accordance with step 640, server 300 updates reservation database, available reservation database, floor plan database, and patron information.

System 100 may identify available table and seating inventory, using software module 304, in step 618 that optimizes restaurant capacity, while considering existing reservations, configurability of floor plan, and overall performance of kitchen and serving staff. For example, system 100 may determine in step 620 that despite a completely reserved restaurant, a two-person walk-in party can be immediately accommodated at a four-person table based upon existing reservations being seated earlier and information from kitchen indicating they are operating at maximum efficiency and completing orders a head of normal schedule, and POS indicating decrease in turnover time. In such instances, seating a smaller party at a larger table may increase overall restaurant capacity.

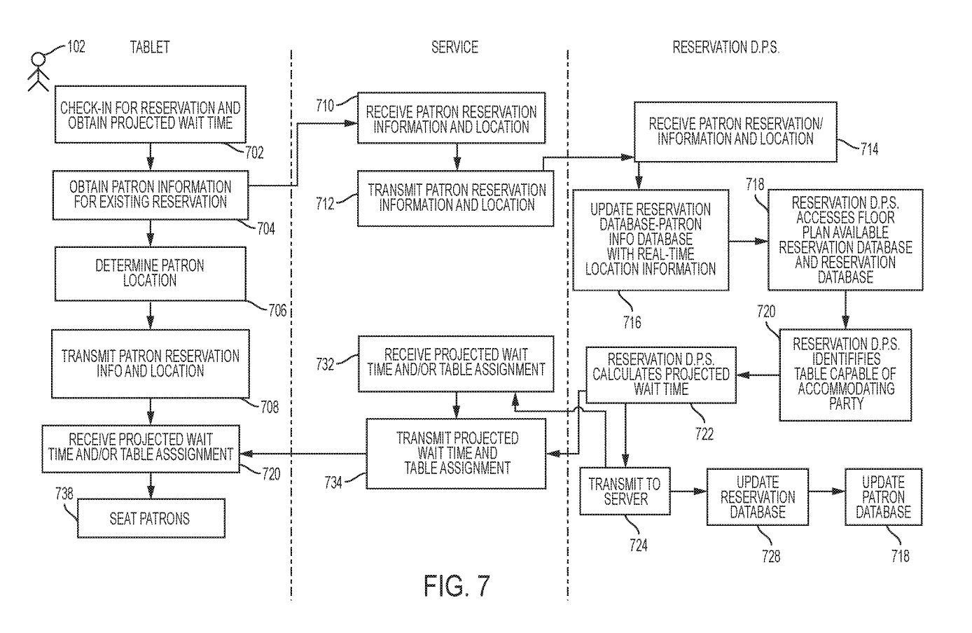

FIG. 7 is a flow chart illustrating an exemplary method 700 by reservation data processing system 100 for forecasting wait times for existing reservations prior to and/or upon arrival at restaurant 106. It is to be understood that the order of the steps depicted in FIG. 7 are by way of illustration, not limitation. As appropriate, a number of the steps can be performed in a different order than presented.

In step 702, patrons with existing reservations may check-in for their reservation and request status and/or expected wait time for their table. This step can be performed once the patron 102 arrives at the restaurant 106 by service staff 110 at host station using tablet 104. In other embodiments, step 702 may be performed by patron 102 on tablet 102 from any remote location.

In step 704, tablet 104 obtains patron information for existing reservation and, in step 706, determines patron's location. Patron's location can be at restaurant 106 when patron is present for check-in. In other embodiments, where patron's check-in remotely, their location can be reported using GPS coordinates and location data of tablet 104 to determine real-time whereabouts.

In step 708, tablet 104 transmits, to server 300, patron reservation information and location and, in step 712, server 300 transmits patron reservation information and location to reservation data processing system 100.

Reservation data processing system 100 receives patron reservation information and location in step 714. In step 716, reservation data processing system 100 updates reservation database and patron information database to reflect estimated and then actual arrival time of patron based on their location.

In step 718, reservation data processing system 100 accesses floor plan to determine plurality of seating configurations for optimizing capacity taking into consideration real-time data (e.g. kitchen performance data, POS data, patron arrival time data, patron location data, etc.), available reservation database, and existing reservation database. In step 720, reservation data processing system 100 using software module 304, identifies a table capable of accommodating reserved party at, or as close to, requested time, which may require reconfiguring restaurant floor plan and other existing reservation table assignments in order to optimize capacity based on actual and estimated arrival times of patrons 102. In step 722, reservation data processing system 100 using software module 306, calculates projected wait time for the table based on table availability and assignments. In step 724, reservation data processing system 100 transmits table assignment information and expected wait time to server 300. It should be understood that in some circumstances there may be a table available for immediate seating, which would require no waiting time.

In step 726, reservation data processing system 100 updates floor plan database to record actual arrival of reservation and assignment of reservation to a specified table. In step 728, reservation data processing system 100 updates reservation database to record actual arrival time of the reservation and the expected wait time, if any. In step 730, reservation data processing system 100 updates patron reservation history within patron information database, to record the actual arrival time of reservation at the restaurant 106 on the specified date and time.

Server 300 receives estimated wait time and/or table assignment for existing reservation in step 732. In step 734, server 300 transmits estimated wait time and/or table assignment information to tablet 104. In step 736, tablet 104 receives estimated wait time and/or table assignment information, which is presented to patron 102. In step 738, if there is no wait time, patrons are seated at the specified assigned table.

It is to be understood that the disclosure describes a few embodiments and that many variations of the invention can easily be devised by those skilled in the art after reading this disclosure and that the scope of the present invention is to be determined by the following claims.

What is claimed is:

1. A method for managing reservations and seating capacity at a business establishment, comprising:
receiving, at a data processing system, a request from a patron to reserve a table, wherein the request includes a party size on a requested date at a requested time;
retrieving, at a data processing system, business information and reservation requirements for the requested date and requested time, wherein the business information includes a plurality of floor plan configuration records from a database associated with the business establishment, the floor plan configuration records having a plurality of tables, each table being listed as available or unavailable;
identifying, at the data processing system, at least one of the plurality of floor plan configuration records having at least one table being listed as available and capable of accommodating the request and satisfying the reservation requirements; and
one of approving or declining the request, at the data processing system, wherein:
the request is approved when the business establishment has at least one available table within at least one floor plan configuration record to satisfy the request and the reservation requirements; and
the request is declined when the business establishment has insufficient available tables within at least one floor plan configuration record to satisfy the request and the reservation requirements.

2. The method of claim 1 wherein approving the request further comprising:
selecting, at the data processing system, an available table within the associated floor plan configuration record; and
assigning, at the data processing system, the selected table to the approved request within the associated floor plan configuration record.

3. The method of claim 2 further comprising:
updating, at the data processing system, the floor plan configuration record by listing the selected table as unavailable; and
updating, at the data processing system, the reservation requirements to include a reservation record for the approved request.

4. The method of claim 3 further comprising:
receiving, at the data processing system, reservation information from a patron via a tablet, the reservation information includes a request to check-in for an existing reservation and a tablet physical location;
determining, at the data processing system, the estimated arrival time of the patron based on the proximity of the tablet location to the business establishment; and
updating, at the data processing system, the reservation record in accordance with the estimated arrival time.

5. The method of claim 3 further comprising:
retrieving, at a data processing system, the reservation record of a patron associated with the reservation requirements;
calculating, at the data processing system, an expected wait time in accordance with the floor plan configuration record and reservation requirements; and
notifying the patron of the expected wait time.

6. The method of claim 1 wherein identifying at least one of the plurality of floor plan configuration records further comprising:
defining, at the data processing system, a set of requirements for a floor plan configuration record;
producing, at the data processing system, all possible floor plan configuration records which satisfy the set of requirements, wherein each possible floor plan configuration record having at least one available table; and
identifying, at the data processing system, a floor plan configuration record which optimizes seating capacity in accordance with the request and the reservation records.

7. The method of claim 6 wherein the set of requirements includes a blocked table list.

8. The method of claim 1 wherein identifying at least one of the plurality of floor plan configuration records further comprising:
retrieving, at the data processing system, a patron record from a database associated with the business establishment, the patron record having a plurality of patron preferences; and
identifying, at the data processing system, at least one of the plurality of tables being listed as available and satisfying the reservation requirements and at least one of the plurality of patron preferences.

9. The method of claim 8 wherein the plurality of patron requirements includes at least one of preferred table location, preferred table type, or preferred server.

10. The method of claim 1 wherein the business information further includes a plurality of databases associated with the business establishment, each database having a plurality of records, each of the plurality of records including a list of data fields for storing real-time business information.

11. The method of claim 10 wherein the plurality of databases includes at least one of table activity, kitchen activity, and server activity.

12. The method of claim 11 further comprising:
monitoring, at the data processing system, a plurality of data fields associated with records from the table activity database, kitchen activity database, and server activity database;
receiving, at the data processing system, a request from a walk-in patron for a table, wherein the request includes a party size;
optimizing, at the data processing system, seating capacity by reconfiguring the plurality of tables within the floor plan configuration record to accommodate the walk-in request and satisfy the reservation requirements in accordance with real-time business information being monitored within the table activity database, kitchen activity database, and server activity database; and
identifying, at the data processing system, at least one available table within the reconfigured floor plan configuration record which satisfies the request and reservation requirements.

13. The method of claim 12 further comprising:
one of available, unavailable, or not yet available table for accommodating the walk-in request, at the data processing system, wherein;
the table is available and the patron is seated;
the table is not available and the patron is turned away; and
the table is not yet available and the patron is provided with an expected wait time.

14. The method of claim 13 further comprising:
calculating, at the data processing system, the expected wait time in accordance with the floor plan configuration record, reservation requirements, and data fields monitored within the table activity database, kitchen activity database, and server activity database; and
notifying the patron of the expected wait time.

15. The method of claim 14 wherein during the expected wait time, recalculating, at least once, at the data processing system, the remaining expected wait time.

16. The method of claim 1 wherein the patron submits a reservation request via a digital computing device.

17. The method of claim 1 wherein the data processing system comprises a server.

18. An article of manufacture including non-transitory, tangible computer readable storage medium having instructions stored thereon that, in response to execution by a processor of a data processing system, cause the data processing system to perform operations comprising:
receiving, at a data processing system, a request from a patron to reserve a table, wherein the request includes a party size on a requested date at a requested time;
retrieving, at a data processing system, business information and reservation requirements for the requested date and requested time, wherein the business information includes a plurality of floor plan configuration records from a database associated with the business establishment, the floor plan configuration records having a plurality of tables, each table being listed as available or unavailable;
identifying, at the data processing system, at least one of the plurality of floor plan configuration records having at least one table being listed as available and capable of accommodating the request and satisfying the reservation requirements; and
one of approving or declining the request, at the data processing system, wherein:
the request is approved when the business establishment has at least one available table within at least one floor plan configuration record to satisfy the request and the reservation requirements; and
the request is declined when the business establishment has insufficient available tables within at least one floor plan configuration record to satisfy the request and the reservation requirements.
